(19) United States
(12) Patent Application Publication
(10) Pub. No.: US 2024/0169727 A1
(43) Pub. Date: May 23, 2024

(54) METHOD AND APPARATUS WITH FRAME CLASS IDENTIFICATION

(71) Applicants: SAMSUNG ELECTRONICS CO., LTD., Suwon-si (KR); Seoul National University R&DB Foundation, Seoul (KR)

(72) Inventors: Bohyung HAN, Seoul (KR); Jong Hyeon SEON, Seoul (KR)

(73) Assignees: SAMSUNG ELECTRONICS CO., LTD., Suwon-si (KR); Seoul National University R&DB Foundation, Seoul (KR)

(21) Appl. No.: 18/355,788

(22) Filed: Jul. 20, 2023

(30) Foreign Application Priority Data
Nov. 17, 2022 (KR) 10-2022-0154562

(51) Int. Cl. G06V 20/40; G06V 10/74; G06V 10/82

(52) U.S. Cl. CPC G06V 20/41; G06V 10/761; G06V 10/82

(57) ABSTRACT

A processor-implemented method includes generating respective final feature vectors of a plurality of frames of time-series data, while sequentially processing the plurality of frames by using a neural network comprising a plurality of layers, determining a class of the time-series data based on at least one final feature vector of the respective final feature vectors, generating a reference feature vector based on the at least one final feature vector, calculating a similarity score between the reference feature vector and a feature vector of at least one second frame, wherein the second frame includes a non-final feature frame where the final feature vector is not generated, and determining the at least one second frame to be the frame corresponding to the class, based on a result of comparing the similarity score and a threshold value.

### CROSS-REFERENCE TO RELATED APPLICATIONS

This application claims the benefit under 35 USC § 119(a) of Korean Patent Application No. 10-2022-0154562, filed on Nov. 17, 2022, in the Korean Intellectual Property Office, the entire disclosure of which is incorporated herein by reference for all purposes.

### BACKGROUND

### 1. Field

The following description relates to a method and apparatus with frame class identification.

### 2. Description of Related Art

As deep learning technology advances, the technology has been widely used in various fields. Deep learning technology has achieved remarkable advancement especially in the image processing field. Accordingly, there is growing interest in technology for obtaining meaningful information from images or videos by using deep learning technology.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method, the method including generating respective final feature vectors of a plurality of frames of time-series data, while sequentially processing the plurality of frames by using a neural network comprising a plurality of layers, determining a class of the time-series data based on at least one final feature vector of the respective final feature vectors, generating a reference feature vector based on the at least one final feature vector, calculating a similarity score between the reference feature vector and a feature vector of at least one second frame, wherein the second frame comprises a non-final feature frame for which the final feature vector is not generated, and determining the at least one second frame to be a frame corresponding to the class, based on a result of comparing the similarity score and a threshold value.

The generating the respective final feature vectors may include determining whether to proceed with a sequence for generating the final feature vector of a frame of the plurality of frames by using the layers for each of the plurality of frames and generating the final feature vector of the frame when the sequence reaches a final stage.

The sequence may include generating feature vectors, for each of a plurality of stages, of the frame by using a first neural network corresponding to each of the stages comprising the sequence and determining whether to proceed with the sequence by using a second neural network corresponding to each of the stages and the feature vectors for each of the stages.

The neural network may be configured to perform an operation for a frame of the plurality of frames based on an internal state of the layers calculated in a previous frame of which a final feature vector is generated.

The determining the class includes determining the class for a first frame including a frame determined to be the frame corresponding to the class of the second frame and a frame of which a final feature vector is generated.

The generating the reference feature vector may include generating reference feature vectors for each stage corresponding to each of stages comprising a sequence.

The generating the reference feature vector may include determining, to be a reference feature vector for each stage, an average of feature vectors for each stage calculated for each of stages comprising a sequence corresponding to each frame of which a final feature vector is generated.

A feature vector of the at least one second frame may include a feature vector for each stage that is generated based on a sequence corresponding to the at least one second frame.

A feature vector of the at least one second frame may include a feature vector for each stage corresponding to a stage at which a sequence stops.

The calculating the similarity score may include calculating a similarity score between a feature vector for each stage corresponding to a stage at which a sequence stops corresponding to the at least one second frame and a reference feature vector for each stage corresponding to a same stage as the stage at which the sequence stops.

The determining whether the at least one second frame to be the frame corresponding to the class may include determining a second frame corresponding to the similarity score to be the frame corresponding to the class when the similarity score is greater than or equal to the threshold value.

When the time-series data is a video for detecting an abnormal situation, the class is the abnormal situation, and a first frame may be a frame corresponding to the abnormal situation.

When the time-series data is a video for detecting an abnormality in a production process, the class may be the abnormality in the production process, and a first frame is a frame corresponding to the abnormality in the production process.

When the time-series data is streaming data and the class may be a streaming filter, a first frame is a filtering target frame.

In a general aspect, here is provided an electronic device including a processor configured to execute a plurality of instructions and a memory storing the plurality of instructions, wherein execution of the plurality of instructions configures the processor to be configured to generate respective final feature vectors of a plurality of frames of time-series data, while sequentially processing the plurality of frames by using a neural network comprising a plurality of layers, determine a class of the time-series data based on at least one final feature vector of the respective final feature vectors, generate a reference feature vector based on the at least one final feature vector, calculate a similarity score between the reference feature vector and a feature vector of at least one second frame, wherein the second frame comprises a non-final feature frame where the final feature vector is not generated, and determine the at least one second frame to be a frame corresponding to the class, based on a result of comparing the similarity score and a threshold value.

A first frame may include a frame determined to be the frame corresponding to the class of the at least one second frame and a final feature frame where the final feature vector is generated.

The processor may be configured to determine, to be a reference feature vector for each stage, an average of feature vectors for each stage calculated for each of stages comprising a sequence corresponding to each frame of which the final feature vector is generated.

A feature vector of the at least one second frame may include a feature vector for each stage corresponding to a stage at which a sequence stops.

The processor may be configured to calculate a second similarity score between a feature vector for each stage corresponding to a stage at which a sequence stops corresponding to the at least one second frame and a reference feature vector for each stage corresponding to the same stage as the stage at which the sequence stops.

In a general aspect, here is provided a processor implemented method including processing, by a series of neural networks, a first frame of a plurality of frames of time-series data in a sequence, determining, whether to stop the processing of the first frame before an end of the sequence, generating a final feature vector for the first frame responsive to reaching the end of the sequence, generating a first frame reference feature vector for the final feature vector, and determining a class of the time-series data based on the final feature vector.

The method may include generating a second frame reference feature vector for a second frame responsive to stopping the processing of the second frame, calculating a similarity score between the first frame reference feature vector and the second frame reference feature vector, and assigning the second frame to the class based on a result of comparing the similarity score and a threshold value.

The processing of the first frame may include sequentially processing each frame of the plurality of frames until reaching the end of the sequence for the each frame or responsive to stopping the processing of the each frame.

Other features and aspects will be apparent from the following detailed description, the drawings, and the claims.

### BRIEF DESCRIPTION OF THE DRAWINGS

FIG. 1 illustrates an example method of determining a class, according to one or more embodiments.

FIG. 2 illustrates an example second neural network according to one or more embodiments.

FIG. 3 illustrates an example method of determining a frame corresponding to a class, according to one or more embodiments.

FIG. 4 illustrates an example process of determining a frame corresponding to a class by an electronic device, according to one or more embodiments.

FIG. 5 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used in connection with various example embodiments of the disclosure, any use of the terms “module” or “unit” means processing hardware, e.g., configured to implement software and/or firmware to configure such processing hardware to perform corresponding operations, and may interchangeably be used with other terms, for example, “logic,” “logic block,” “part,” or “circuitry”. As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

Due to manufacturing techniques and/or tolerances, variations of the shapes shown in the drawings may occur. Thus, the examples described herein are not limited to the specific shapes shown in the drawings, but include changes in shape that occur during manufacturing.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Approaches for classifying images or videos into certain classes include using deep learning technology. Technology for classifying images or videos into certain classes may be referred to as image classification technology. An output of a neural network may be a probability of input data being a certain kind of class. In this classification approach, for input data (e.g., an image or series of images), among the classes, the class having a highest probability may be determined to be the class that corresponds to the input data.

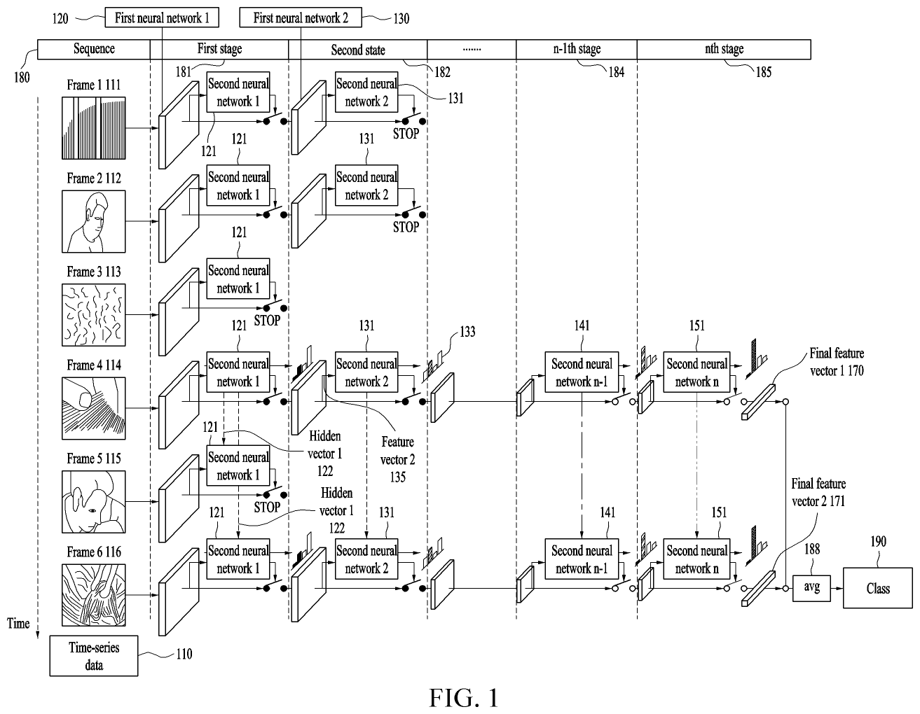

FIG. 1 illustrates an example method of determining a class, according to one or more embodiments.

In a non-limiting example, FIG. 1 illustrates frames 1-6 and 111-116. FIG. 1 also includes first, second, n−1th, and nth stages 181, 182, 184, and 185 included in a sequence 180, a first neural network 1 120 may be included within the first stage 181, a second neural network 1 121 may be included within the first stage 181, a second neural network 2 131 may also be included within the second stage 182. A hidden vector 1 122 and a feature vector 2 135 are generated by using a first neural network 2 130 of the second stage 182. A class 133 is generated by using the second neural network 2 131, a second neural network n−1 141 included in the n−1th stage 184, a second neural network n 151 of the nth stage 185, a final feature vector 1 170, a final feature vector 2 171, and a class 190.

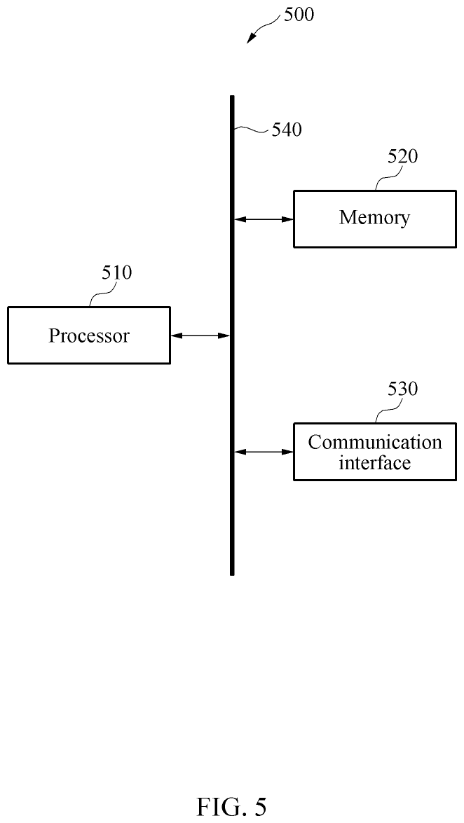

The various second neural networks 1 through n may be a series of next neural networks that may be applied to a frame. Accordingly, in another example, the second neural network 2 131, for example, may be considered a third neural network for ease of understanding. The second neural network n 151 would be the last neural network in the series of neural networks. If there were 10 stages within the sequence 180, then second neural network n 151 on nth stage 185 would be the tenth neural network within stage 10 while neural network n−1 141 would be the ninth neural network, being within stage 9, in this example. A processor 510 of FIG. 5 may receive time-series data 110 including the frames 1-6 and 111-116. The frames 1-6 and 111-116 may be video images where the video images include audio and video data. Each frame may be related to a certain class of (or associated with) a segment of one or more frames within the stream of video images. In the example of FIG. 1, the frames 1-6 and 111-116 may be generally related to cooking and, in particular, the cooking of pasta. Examples of the classes that may be derived from the examples of frames 1-6 and 111-116 are described below but may include, for example, the “process of preparing pasta.” In a non-limiting example, the final feature vector may establish a class marker for different segments of the stream of video images.

The processor 510 may sequentially process the frames 1-6 and 111-116 by using a neural network including a plurality of layers.

The processor 510 may generate a final feature vector of at least some of the frames 1-6 and 111-116. For example, the processor 510 may generate the final feature vector 1 170 of the frame 4 114 by using the neural network including the layers. As another example, the processor 510 may generate the final feature vector 2 171 of the frame 6 116 by using the neural network including the layers.

In a non-limiting example, the processor 510 may determine whether to proceed with or stop a sequence (e.g., sequence 180) for generating a final feature vector. That is, in an example, determination of a final feature vector may be postponed until frames containing a different class are reached. Thus, within a series of frames having a similar class, the processor 510 may forego generating a final feature vector as this may save processing costs and/or time (i.e., improve throughput). In some instances, some frames may not be useful for determining a class. In other instances, some frames are useful for determining a class. Even where some frames may be useful for determining a class, they may overlap with previous and/or subsequent frames and these overlapping frames may likewise be not used for creating a final feature vector. That is, some frames may be relevant but are not used for creating a final feature vector. In some examples, the processor 510 may be configured or trained to distinguish between frames that initiate the generation of the final feature vector for frames within a class and frames that do not.

The processor 510 may obtain a feature vector of the frame 1 111 by using the first neural network 1 120. The feature vector of the frame 1 111 is input to the second neural network 1 121. The processor 510 may determine whether to proceed with or stop a sequence for generating a final feature vector corresponding to the frame 1 111 by using the second neural network 1 121. The processor 510 may determine to proceed with the sequence by using the second neural network 1 121. To do so, the feature vector of the frame 1 111 (generated by using the first neural network 1 120) is input to the first neural network 2 130 included in a next stage. The feature vector of the frame 1 111 may be input to the second neural network 2 131. The processor 510 may determine whether to proceed with or stop the sequence by using the second neural network 2 131. The processor 510 may stop the sequence. In other words, the processor 510 may determine that the frame 1 111 is unnecessary for obtaining an accurate class. Accordingly, the processor 510 may not generate the final feature vector of the frame 1 111; stopping a sequence for an unnecessary frame may decrease a throughput for determining a class.

In an example, when a sequence has been determined to have reached a final stage, the processor 510 may generate a final feature vector of a frame. The final stage of the sequence may be the nth stage 185. The sequence may include a plurality of stages. The determining of whether a frame should produce a final feature frame may proceed through one or more of the stages as described below.

In an example, the processor 510 may generate the final feature vector 1 170 for the frame 4 114. The sequence may be proceeded to the nth stage 185, that is, the final stage, for the frame 4 114. The processor 510 may determine that the frame 4 114 is necessary for determining a class by using the neural network including the layers. The processor 510 may determine whether to proceed with a sequence through each stage within the sequence by using the second neural network 1 121, the second neural network 2 131, the second neural network n−1 141, and the second neural network n 151 that are respectively included in the stages of the sequence. That is, in this example, each neural network determined that it should proceed to the next neural network within first neural network 2 130. For example, the processor 510 may determine whether to proceed from the first stage 181 to the second stage 182 by using the second neural network 1 121 included in the first stage 181. The processor 510 may determine to proceed from the first stage 181 to the second stage 182 for the frame 4 114. By repeating the above process, the processor 510 may reach the nth stage 185. The processor 510 may determine whether to proceed with or stop the sequence by using the second neural network n 151 of the nth stage 185. When proceeding with the sequence, the processor 510 may determine a feature vector obtained from a first neural network n of the nth stage 185 to be the final feature vector 1 170. Accordingly, in this example, frame 4 114 has ultimately led to the generation of the final feature vector 1 170.

The processor 510 may determine the class 190 corresponding to the time series data 110, based on the final feature vector of at least some of the frames 1-6 and 111-116. In an example, time-series data may be a series of data aligned with time. The time-series data may include a plurality of frames. For example, the time-series data may include video data, voice data, sensor data, and the like. An inferred class may be a classification result. The class may indicate the content included in the time-series data. For example, when the time-series data is a food-related video, the class may be “pasta making”, “pizza making”, “steak making”, and the like. In an example, the processor 510 may determine the class 190 corresponding to the time-series data 110, based on the final feature vector 1 170 and the final feature vector 2 171, which are the final feature vectors of frames 4 and 6, and 114 and 116, respectively. For example, the processor 510 may determine the class 190 by concatenating the final feature vector 1 170 and the final feature vector 2 171. The frames 1-6 and 111-116 may include the content of a “process of preparing pasta”. Accordingly, the processor 510 may generate the final feature vectors 1 and 2 170 and 171 (of the frames 4 and 6 114 and 116) including the core content of the “process of preparing pasta” and determine the class 190 based on the generated final feature vectors 1 and 2 170 and 171. Therefore, in this example, the class 190 generated by using a neural network by the processor 510 may be “process of preparing pasta”.

In FIG. 1, AVG 188 may be a decision making point at which one or more of the various final feature vectors can be employed to determine a class for the time series data. Thus, class 190 is derived by the analysis of AVG 188 where AVG considers final feature vector 1 170 and final feature vector 2 171. In one example, the AVG 188 decision may be based on an average value of input final feature vectors. In another example, the AVG 188 may determine a class 190 based on a most frequent final feature vector value, a mean of the final feature vector values, or a most likely class of the final feature vector values.

In an example, the neural network may perform an operation for a certain frame, based on an internal state of a plurality of layers calculated in a previous frame of which a final feature vector is generated. There may be one or more neural networks employed to perform these operations. The frame 4 114 may be a frame of which the final feature vector 1 170 is generated. The certain frame may be frame 5 115. Frame 4 114 may directly precede frame 5 115. When proceeding with the sequence for frame 5 115, the processor 510 may perform an operation for frame 5 115, based on an internal state of the layers calculated in frame 4 114. In a sequence of generating the final feature vector 1 170 of frame 4 114, the processor 510 may use, for the operation of frame 5 115, hidden vector 1 122, where the hidden vector 1 122 is obtained by using the second neural network 1 121 in the first stage 181. For example, the processor 510 may use hidden vector 1 122 in the first stage 181 of frame 5 115. The processor 510 may determine whether to proceed with or to stop the sequence by inputting hidden vector 1 122 to the second neural network 1 121. In addition, the processor 510 may use information based on a previous frame from which a final feature vector is generated during an operation being performed on a current frame. In this case, the processor 510 may analyze the relevance between the current frame and the content of a previous frame (that includes core content) for determining the class 190 and determine whether the current frame is helpful for generating the class 190. That is, the processor 510 may be provided with information from previous frames when considering an action for a current frame.

In an example, one or more of the neural networks (e.g., first neural networks 120 and 130 and second neural networks 121-151) may include a neural network trained based on the class 190, that is, ground truth data and the time-series data 110. For example, training data may include the time-series data 110 including the content of preparing pasta, as input data, and the class 190 of a “pasta preparing image”, as ground truth data. The processor 510 may train the neural network to determine the class 190 corresponding to the time-series data 110 with respect to the time-series data 110.

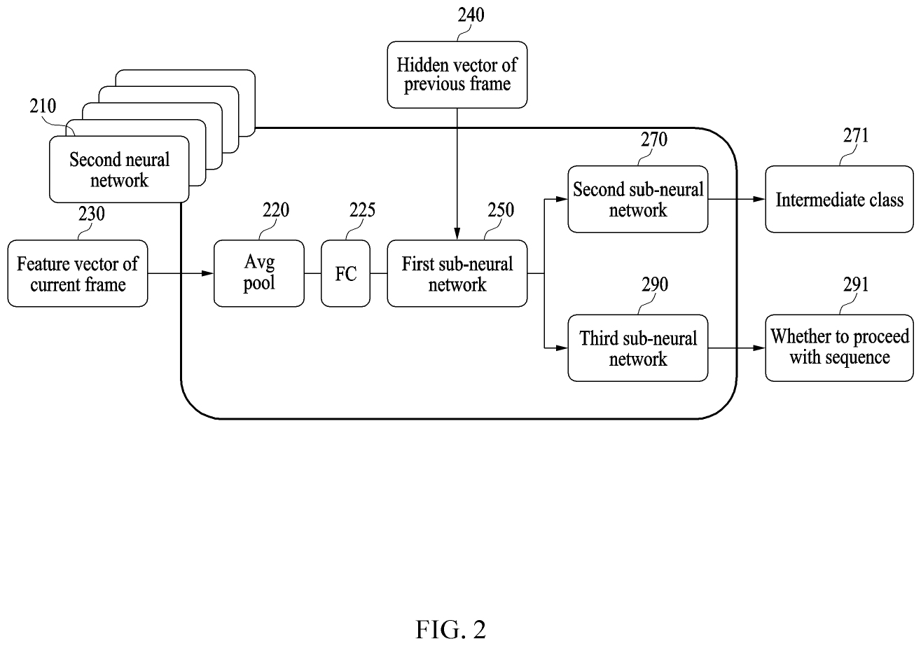

The neural network may include a plurality of layers. The neural network may include a plurality of first neural networks and a plurality of second neural networks. The neural network may include a first neural network and a second neural network corresponding to each stage of a sequence. The first neural network may be a neural network for extracting a feature from an image. The first neural network may include any one or any combination of at least one convolutional layer and at least one pooling layer to extract a feature from an image. An example of the second neural network is described in greater detail below in FIG. 2.

In a non-limiting example, the neural network may be trained based on a loss function. The loss function may be a function representing a difference between an actual value and a predicted value of the neural network generated through the training. The processor 510 may train the neural network to decrease the loss function in a neural network training process.

The loss function may include a first loss function, a second loss function, and/or a third loss function, in which the first loss function is configured to increase the inference accuracy of a class, the second loss function is configured to decrease a throughput, and the third loss function is configured to increase the prediction accuracy of the second neural network.

In an example, the first loss function may be configured to decrease a difference between ground truth (label) data and an inference class obtained by the processor 510 by using the neural network. For example, the inference class obtained by the processor 510 by using the neural network in the neural network training process may be a “probability of being a pasta preparing image: 0.6”, and the ground truth data may be a “probability of being a pasta preparing image: 1”. In this case, the processor 510 may update parameters of the neural network to decrease the difference between the ground truth data and the inference class.

In an example, the second loss function may be configured to minimize a throughput for generating the class 190 by using the neural network. For example, when the processor 510 proceeds with a sequence for a certain frame, the throughput may increase whenever the sequence's stages proceed. In this case, the processor 510 may use frame information and information on each of the stages of the sequence when calculating the throughput. The frame information may include, for example, the size of a frame. In addition, the information on each of the stages of the sequence may include a predicted throughput for each of the stages. However, when not generating a final feature vector of the certain frame, the throughput may decrease as the processor 510 terminates the sequence for the certain frame earlier. Accordingly, when determining whether to proceed with the sequence by using the second neural network, the processor 510 may also depend on the throughput information for generating the final feature vector of the certain frame. The processor 510 may train the second neural network such that the sequence for a frame of which a final feature vector is less likely to be generated may be terminated as early as possible.

In an example, the third loss function may be configured to increase the accuracy of the second neural network that determines whether to proceed with or terminate a sequence. For example, the third loss function may include at least one of a first sub-loss function and a second sub-loss function, in which the first sub-loss function is configured to increase the class inference accuracy of a second sub-neural network 270 (FIG. 2) and the second sub-loss function is configured to increase the accuracy of determining whether to proceed with a sequence by a third sub-neural network 290 (FIG. 2).

In an example, the first sub-loss function may find a difference between ground truth data (e.g., a probability of being a pasta preparing image: 1) and a predicted class (e.g., a probability of being a pasta preparing image: 0.6) obtained by the second sub-neural network 270. The processor 510 may determine whether the prediction class generated by using the second sub-neural network 270 (included in each of the stages of the sequence) is accurate, and in the neural network training process, may update the parameters of the neural network to decrease the size of the first sub-loss function.

In an example, the second sub-loss function may find a difference between ground truth data and a determination of whether to proceed with a prediction sequence obtained by using the third sub-neural network 290. For example, the determination of whether to proceed with the prediction sequence obtained by the processor 510 by using the third sub-neural network 290 may be an indication to “proceed”. The ground truth data, however, may be an indication to “stop”. In this case, the processor 510 may update the neural network to decrease the difference between the ground truth stop-proceed data and the predicted determination of whether to proceed with the prediction sequence.

In an example, a sequence may include a plurality of stages for generating a final feature vector. The sequence may generate a feature vector of a frame for each of the stage by using a first neural network corresponding to the stages included in the sequence. For example, the processor 510 may generate a feature vector for the first stage 181 by using the first neural network 1 120 of the first stage 181. As another example, the processor 510 may generate a feature vector for the second stage 182 by using the first neural network 2 130 of the second stage 182.

In an example, the processor 510 may determine whether to proceed with or stop the sequence by using the feature vector for each of the stages and the second neural network corresponding to each of the stages. For example, the processor 510 may determine whether to proceed to the second stage 182 or stop the sequence at the first stage 181 by using the second neural network 1 121 of the first stage 181. As another example, the processor 510 may determine whether to proceed to a third stage or stop at the second stage 182 by using the second neural network 2 131 of the second stage 182.

FIG. 2 illustrates an example of a second neural network according to an embodiment according to one or more embodiments.

FIG. 2 illustrates a second neural network 210, a feature vector 230 of a current frame, a hidden vector 240 of a previous frame, a first sub-neural network 250, a second sub-neural network 270, a third sub-neural network 290, an intermediate class 271, and operation 291 of determining whether to proceed with a sequence.

The second neural network 210 may be trained to determine whether to proceed with or stop a sequence based on a feature vector generated by using a first neural network. A processor 510 of FIG. 5 may determine whether to proceed with a sequence by using the second neural network 210. For example, when an output value obtained by using the second neural network 210 is 1, the processor 510 may proceed with the sequence. As another example, when the output value obtained by using the second neural network 210 is 0, the processor 510 may stop the sequence.

The second neural network 210 may be trained to determine whether to proceed with or stop a sequence based on a feature vector generated by using the first neural network included in the same stage as that of the second neural network 210 among the first, second, n−1th, and nth stages 181-185 of FIG. 1 of the sequence 180. For example, the processor 510 may obtain a feature vector of the frame 1 111 illustrated in FIG. 1 by using the first neural network 1 120 of the first stage 181. The processor 510 may input the feature vector to the second neural network 1 121. The processor 510 may determine whether to proceed with or stop a sequence for generating a final feature vector of the frame 1 111 by using the second neural network 1 121.

The second neural network 210 may include a normalization layer for normalizing output data to an integer. For example, the integer may be 0 or 1. The normalization layer may be, for example, Gumbel-Softmax distribution. In this case, the processor 510 may determine whether to proceed with or stop a sequence by using the second neural network 210, based on a value of 0 or 1, that is, a result of Gumbel-Softmax distribution.

The second neural network 210 may include the first sub-neural network 250 trained to store information on a previous frame, the second sub-neural network 270 trained to generate a class, and the third sub-neural network 290 trained to determine whether to proceed with or stop a sequence. As illustrated in FIG. 2, the processor 510 may obtain pieces of output data by using the second neural network 210. The processor 510 may obtain the intermediate class 271 or instead proceed with operation 291 of determining whether to proceed with a sequence by using the second neural network 210. The processor 510 may generate the intermediate class 271 by using the second sub-neural network 270 of the second neural network 210. The processor 510 may determine whether to proceed with a sequence in operation 291 by using the third sub-neural network 290 included in the second neural network 210.

The first sub-neural network 250 may be trained to store information on a previous frame. The first sub-neural network 250 may be a neural network trained to store information on a previous frame of which a final feature vector is generated. In a non-limiting example, the first sub-neural network 250 may include average pooling, max pooling, self-attention, and/or long short-term memory (LSTM). In an example, the first sub-neural network 250 may receive, as an input, the hidden vector 240. The first sub-neural network 250 may receive, as an input, the feature vector 230 of a current frame. In another example, the first sub-neural network 250 may also receive, as an input, data on which operations using an average pooling layer 220 (avg pool) and a fully connected layer (FC) 225 illustrated in FIG. 2 are performed. For example, in FIG. 1, a current frame may be the frame 6 116, and a previous frame may be the frame 4 114 of which the final feature vector 1 170 is generated. In this case, the processor 510 may use the hidden vector 1 122 in the first stage 181 of the frame 6 116. The processor 510 may determine whether to proceed with or stop the sequence by inputting the hidden vector 1 122 to the second neural network 1 121. For example, the processor 510 may input the hidden vector 1 122 to the first sub-neural network 250. The processor 510 may determine whether to proceed with a sequence in operation 291 by inputting data obtained from the first sub-neural network 250 to the third sub-neural network 290.

The second sub-neural network 270 may be trained to generate the intermediate class 271. The second sub-neural network 270 may obtain the intermediate class 271 for each stage within a sequence, and the processor 510 may determine whether the intermediate class 271 obtained by using the second sub-neural network 270 is the same as ground truth data. For example, as illustrated in FIG. 1, the intermediate class 271 may be the class 133 generated by the processor 510 by using the second neural network 2 131. In other words, the intermediate class 271 may be a class obtained in an intermediate stage of the sequence. In a neural network training process, the processor 510 may train a neural network such that the intermediate class 271 obtained by using the second sub-neural network 270 may be the same as (or approach) the ground truth data. In other words, for each stage of the sequence, the processor 510 may update the neural network by examining a calculated intermediate class. Accordingly, the processor 510 may improve class prediction accuracy by finely adjusting the parameters of a first neural network and a second neural network of each stage. The processor 510 may not use the second sub-neural network 270 in a class inference process using the trained neural network. In other words, the second sub-neural network 270 may only be used in the neural network training process.

The third sub-neural network 290 may include a neural network trained to determine whether to proceed with or stop a sequence. The processor 510 may generate output data in integer form by inputting data (e.g., a probability distribution) generated by using the third sub-neural network 290 to a normalization layer (e.g., Gumbel-Softmax distribution). Accordingly, operation 291 of determining whether to proceed with a sequence may be represented by an integer of 1 or 0. For example, when the output data is 1, the processor 510 may proceed with the sequence, and when the output data is 0, the processor may stop the sequence.

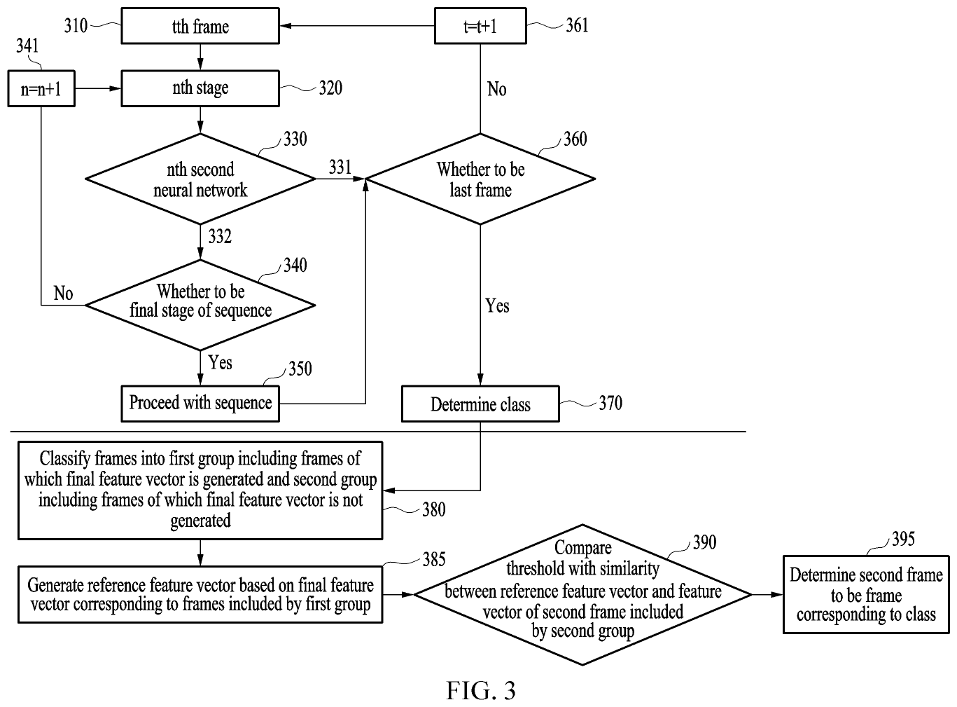

FIG. 3 illustrates an example of a method of determining a frame corresponding to a class, according to an embodiment.

In a non-limiting example, frames that are used to generate a final feature vector may be those frames that are deemed important in determining a class. Accordingly, the frames from which final feature vector is generated (e.g., final feature frames) may be frames that correspond to the class. The frames corresponding to the class may be frames that include content corresponding to the class. For example, when the class is a “pasta making video”, frames that include pasta making content may be the frames that correspond to the class. However, there may be frames corresponding to the class from which a final feature vector is not generated (e.g., non-final feature frames). For example, when the class is “pasta making video”, there may be frames corresponding to the class other than the frames 4 and 6 114 and 116 of FIG. 1. That is, there may be frames corresponding to the “pasta making video” class among the frames that are deemed non-final feature frames because, to decrease a throughput, a final feature vector may not be generated for at least one frame that includes the same or similar content as the frames from which the final feature vector is generated. Because the processor 510 may determine whether to stop a sequence by using a hidden vector, the processor 510 may stop the sequence in such a manner that a final feature vector is not be generated for a frame that has overlapping content with the content of the frames for which the final feature vector is generated. For example, the frame 5 115 may be a frame corresponding to the class, but a final feature vector of the frame 5 115 may not be generated because the content of the frame 5 115 overlaps with the content of the frame 4 114. Therefore, since the frames that include the same or similar content as the frames from which a final feature vector is generated have overlapping content, a final feature vector may not be generated for those frames.

However, a user may intend to manually identify all the frames corresponding to the class from time-series data. In this case, the processor 510 may identify the frames corresponding to the class among the frames of which the final feature vector is not generated (e.g., non-final feature frames), besides the frames of which the final feature vector is generated (e.g., final feature frames).

For example, when the time-series data is a video, and the class is an “illegal situation”, the processor 510 may identify all the frames in which an “illegal situation” occurs from the time-series data.

For example, when the time-series data is a video, and the class is an “abnormal situation in a semiconductor process”, the processor 510 may identify all the frames in which an “abnormal situation” occurs from the time-series data.

For example, when the time-series data is a video, and the class is a “semiconductor defect image”, the processor 510 may identify frames including a “semiconductor defect” in a semiconductor process from the time-series data.

For example, when the time-series data is voice data, and the class is the “voice of a celebrity A”, the processor 510 may identify frames including the “voice of the celebrity A” from the time-series data.

The method of identifying the frames corresponding to the class by the processor 510 is described in detail below with respect to FIG. 3.

The processor 510 may receive, as an input, tth frame 310 included within the time-series data 110 of FIG. 1. For example, the tth frame 310 may be one of the frames 1-6 and 111-116 of FIG. 1.

The processor 510 may proceed with a sequence for generating a final feature vector of the tth frame 310. The processor 510 may perform an nth stage 320 included in the sequence for the tth frame 310. For example, the nth stage 320 may be the second stage 182 of FIG. 1.

The processor 510 may determine whether to proceed with a sequence with path 332 or to stop the sequence with path 331 according to a result of the determination operation 330 that includes determining whether the nth stage 320 is a last frame (operation 360) or whether the final stage of a sequence (operation 340). For example, when the nth stage 320 is the second stage 182, the processor 510 may determine whether to proceed with the sequence with path 332 or to stop the sequence with path 331 by using the second neural network 2 131 of the second stage 182. In this example, because the second stage 182 is not a final stage, the result of operation 340 is that operation 340 is the next operation.

When proceeding with the sequence with path 332, the processor 510 may determine whether the nth stage 320 is a final stage of the sequence in operation 340. When the nth stage 320 is not the final stage of the sequence, the processor 510 may perform an n+1th stage through operation 341. When the nth stage 320 is the final stage of the sequence, the processor 510 may perform operation 350 to proceed with the sequence. The processor 510 may then determine whether the tth frame 310 is a last frame in operation 360. When the tth frame 310 is not the last frame, the processor may perform operation 361. The processor 510 may prepare to initiate a sequence for generating a final feature vector of a t+1th frame, that is, the next frame of the tth frame 310, in operation 361. When the tth frame 310 is the last frame, the processor 510 may perform operation 370. The processor 510 may determine a class in operation 370, based on at least one generated final feature vector.

In a non-limiting example, a first frame may be a frame corresponding to a class of time-series data. The first frame may include a plurality of frames, where the frames may include at least one of a final feature frame or a frame determined to be a frame corresponding to a class among at least one second frame. The at least one second frame may be frames where a final feature vector was not generated (e.g., non-final feature frames). As another example, a group including frames corresponding to the class of the time-series data may be a first group. In addition, a group including non-final feature frames may be a second group.

When the processor 510 determines a class, an initial first group may include frames of which a final feature vector is generated (e.g., final feature frames), and an initial second group may include frames of which a final feature vector is not generated (e.g., non-final feature frames). The processor 510 may identify at least one frame corresponding to the class among the frames of the second group by using a reference feature vector and include the at least one identified frame in the first group.

The processor 510 may classify the frames in operation 380 into the first group (e.g., the initial first group) of frames of which the final feature vector is generated and the second group (e.g., the initial second group) of frames of which the final feature vector is not generated. That is, the first group may include final feature frames and the second group may include non-final feature frames.

The processor 510 may generate the reference feature vector based on the final feature vector corresponding to the frames of the first group (e.g., the initial first group) in operation 385. Hereinafter, the process of generating the reference feature vector is described in detail.

The processor 510 may generate the reference feature vector based on at least one final feature vector. The reference feature vector may be used to identify the frames corresponding to the class from the second group. The reference feature vector may be for calculating a similarity with a feature vector for each stage of a frame. In an example, the similarity may be referenced as a similarity score. Accordingly, as the similarity score of the feature vector for each stage of the frame with the reference feature vector increases, the frame may more likely be a frame corresponding to the class.

The processor 510 may generate a reference feature vector for each stage corresponding to each of the stages of a sequence. Referring to FIG. 1, the sequence 180 may include the first stage 181, the second stage 182, the n−1th stage 184, and the nth stage 185. The processor 510 may generate reference feature vectors for each stage corresponding to the first stage 181, the second stage 182, the n−1th stage 184, and the nth stage 185.

The processor 510 may determine an average of feature vectors for each stage, where the average may be calculated for each of the stages included within the sequence, where the stages may respectively correspond to at least one final feature frame that may be provided as a reference feature vector for each stage. Referring to FIG. 1, the at least one frame of which the final feature vector is generated (e.g., final feature frames) may be the frames 4 and 6 114 and 116. The reference feature vector for each stage corresponding to the first stage 181 may be an average of a feature vector generated in the first stage 181 of the frame 4 114 and a feature vector generated in the first stage 181 of the frame 6 116. The feature vector generated in the first stage 181 may be output data of a first neural network of the first stage 181. The reference feature vector for each stage corresponding to the second stage 182 may be an average of a feature vector generated in the second stage 182 of the frame 4 114 and a feature vector generated in the second stage 182 of the frame 6 116. The feature vector generated in the second stage 182 may be output data of a first neural network of the second stage 182.

In an example, the processor 510 may calculate a similarity between the reference feature vector and a feature vector of the at least one second frame (e.g., non-final feature frames). The processor 510 may determine whether to determine the at least one second frame to be a frame corresponding to the class, based on a comparison result between at least one similarity score and a threshold value. The processor 510 may compare the threshold value with a value of a similarity score between the reference feature vector and a feature vector of a second frame included in the second group.

The feature vector of the second frame may include at least one feature vector for each stage generated based on a sequence corresponding to the second frame. The feature vector of the second frame may include feature vectors for each stage generated until the sequence stops. Referring to FIG. 1, the second frame may be the frame 1 111, the frame 2 112, the frame 3 113, and the frame 5 115. For example, the sequence of the frame 1 111 may stop at the second stage 182. In this case, the feature vector of the second frame may include at least one of a feature vector for each stage corresponding to the first stage 181 of the frame 1 111 and a feature vector for each stage corresponding to the second stage 182 of the frame 1 111. The processor 510 may calculate a similarity with the reference feature vector for each stage corresponding to a stage by selecting one of the feature vectors for each stage within the feature vector of the second frame.

The feature vector of the second frame may be a feature vector for each stage corresponding to a stage at which a sequence stops. For example, the sequence of the frame 1 111 may stop at the second stage 182. In this case, the feature vector of the second frame may be a feature vector for each stage corresponding to the second stage 182, that is, a stopped stage. A feature vector of the stopped stage may be used because the feature vector of the stopped stage may likely include more content of a frame than a feature vector of the previous stage of the stopped stage. Accordingly, the accuracy of identifying a frame corresponding to the class may increase.

In an example, the processor 510 may calculate a similarity between the reference feature vector and a feature vector of at least one second frame. The processor 510 may calculate a similarity between a feature vector for each stage corresponding to a stage at which a sequence stops corresponding to the at least one second frame and a reference feature vector for each stage corresponding to the same stage as the stage at which the sequence stops. Referring to FIG. 1, the second frame may be the frame 1 111, and the sequence of the frame 1 111 may stop at the second stage 182. The stage at which the sequence stops corresponding to the at least one second frame may be the second stage 182. The feature vector for each stage corresponding to the stage at which the sequence stops may be a feature vector for each stage corresponding to the second stage 182 of the frame 1 111. The feature vector for each stage corresponding to the second stage 182 may be output data of a first neural network included in the second stage 182. The same stage as the stopped stage may be the second stage 182. The reference feature vector for each stage corresponding to the same stage as the stopped stage may be a reference feature vector corresponding to the second stage 182. Accordingly, the processor 510 may calculate a similarity between the reference feature vector for each stage corresponding to the second stage 182 and the feature vector for each stage corresponding to the second stage 182 of the frame 1 111. The similarity score may be determined based on a distance between feature vectors. For example, the similarity score may be at least one of a cosine similarity, a Euclidean distance, and a Pearson similarity.

In an example, the processor 510 may determine the at least one second frame to be a frame corresponding to the class based on a comparison result between at least one similarity and a threshold value. The threshold value may be determined based on a degree of correspondence between content of a frame and the class. For example, the threshold value may be a similarity score of 0.9. The similarity score of 0.9 may be a probability that the frame corresponds to the class being 90%. When the similarity score is greater than or equal to the threshold value in operation 395, the second frame corresponding to the similarity score may be determined to be the frame corresponding to the class. For example, when the similarity score is greater than or equal to 0.9, the processor 510 may determine the second frame to be the frame corresponding to the class. The processor 510 may determine the second frame to be the first frame. As another example, the processor 510 may move the second frame from the second group to the first group.

In an example, the processor 510 may compare at least one similarity score with the threshold value. For example, there may be at least one second frame. Referring to FIG. 1, the at least one second frame may be the frame 1 111, the frame 2 112, the frame 3 113, and the frame 5 115. The processor 510 may calculate a similarity between the reference feature vector for each stage corresponding to the same stage as the stopped stage and the feature vector for each stage of the stage at which the sequence of the frame 1 111 stops, a similarity between the reference feature vector for each stage corresponding to the same stage as the stopped stage and the feature vector for each stage of the stage at which the sequence of the frame 2 112 stops, a similarity between the reference feature vector for each stage corresponding to the same stage as the stopped stage and the feature vector for each stage of the stage at which the sequence of the frame 3 113 stops, and a similarity between the reference feature vector for each stage corresponding to the same stage as the stopped stage and the feature vector for each stage of the stage at which the sequence of the frame 5 115 stops. The processor 510 may determine the frame corresponding to the class by comparing each of the above similarity scores with the threshold value.

The processor 510 may output obtained first frames after operation 395 is terminated. A user may view the frames corresponding to the class through a screen. The method of identifying the frames corresponding to the class may be used in various fields of application.

When the time-series data is a video for detecting an abnormal situation, the class may be the abnormal situation, and the first frame may be a frame corresponding to the abnormal situation. The abnormal situation may be an unusual, dangerous situation, such as a human action. Accordingly, the processor 510 may identify frames in which the abnormal situation occurs by using a neural network including a plurality of layers. The processor 510 may identify the time of occurrence of the abnormal situation by using time information corresponding to the identified frames. In this case, the processor 510 may stop a sequence at an intermediate stage for a frame including a normal situation while proceeding with the sequence to a final stage for a frame including an abnormal situation and generating a final feature vector. The processor 510 may concentrate a throughput on an interesting frame by using the neural network including the layers, minimize a throughput for an uninteresting frame, and effectively decrease an entire throughput.

In an example, when the time-series data is a video for detecting an abnormality in a production process, the class may be a production process abnormality. The production process abnormality may be an abnormal situation occurring in a production process of a product. The first frame may be a frame corresponding to the production process abnormality. The production process may be, for example, a semiconductor manufacturing process. The processor 510 may identify frames in which the production process abnormality occurs by using the neural network including the layers. The processor 510 may identify the time of occurrence of the abnormality in the production process by using time information corresponding to the identified frames.

When the time-series data is streaming data, and the class is a streaming filter, the first frame may be a filtering target frame. In a streaming service in which people communicate with one another through video, such as one-to-one, one-to-many, and many-to-one, the processor 510 may efficiently detect, through the neural network including the layers, a frame including illegal content (e.g., violent content, obscene content, and the like of which broadcasting is regulated according to the laws and regulations of each country). The streaming filter may be a filter for filtering a frame including illegal content in a streaming environment. The filtering target frame may be a frame including illegal content. The processor 510 may generate a final feature vector of the filtering target frame, identify frames corresponding to the class, and remove the filtering target frame from the time-series data. In addition, the identified frames may be used as evidence of a criminal act.

When identifying the frames corresponding to the class by using the method described above, a throughput may decrease because all the stages within a sequence may not need to be performed on all the frames of the time-series data. The processor 510 may proceed with a sequence for generating a final feature vector to a final stage for a minimum number of frames to determine a class corresponding to the time-series data, determine whether the rest of the frames corresponds to the class through a similarity with a reference feature vector, and identify all the frames corresponding to the class from the time-series data.

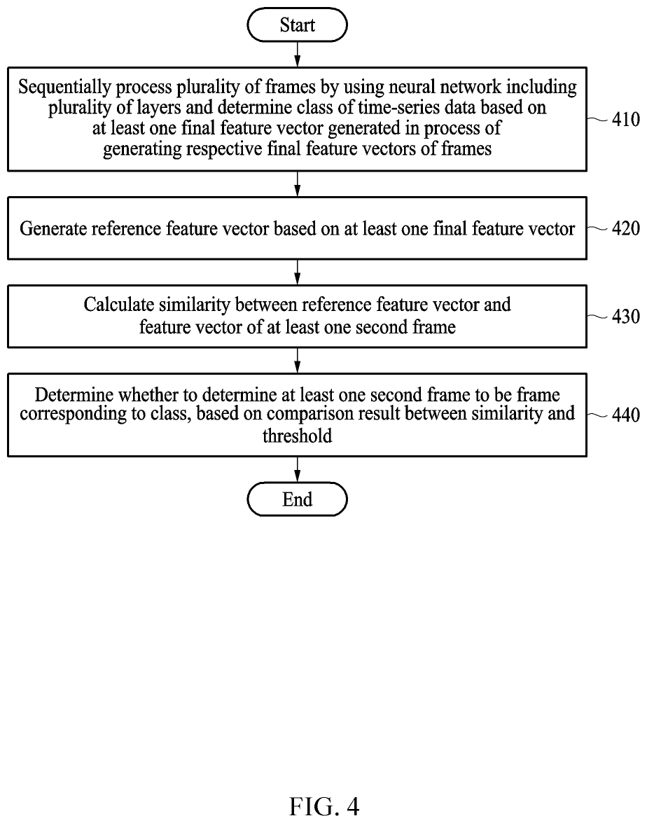

FIG. 4 illustrates an example of a process of determining a frame corresponding to a class by an electronic device, according to an embodiment.

An electronic device 500 of FIG. 5 may sequentially process a plurality of frames by using a neural network including a plurality of layers and determine a class of time-series data based on at least one final feature vector generated in a process of generating respective final feature vectors of the frames in operation 410.

The electronic device 500 may generate a reference feature vector, in operation 420, based on the at least one final feature vector.

The electronic device 500 may calculate a similarity between the reference feature vector and a feature vector of at least one second frame in operation 430.

The electronic device 500 may determine whether to determine the at least one second frame to be a frame corresponding to the class, based on a comparison result between the similarity score and a threshold value.

FIG. 5 illustrates an example of an electronic device according to an embodiment.

Referring to FIG. 5, an electronic device 500 may include a memory 520, a processor 510, and a communication interface 530. The memory 520, the processor 510, and the communication interface 530 may be connected to each other via a communication bus 540.

The processor 510 may further execute programs, and/or may control the electronic device 500, and may include any one or a combination of two or more of, for example, a central processing unit (CPU), a graphic processing unit (GPU), a neural processing unit (NPU) and tensor processing units (TPUs), but is not limited to the above-described examples.

The memory 520 may include computer-readable instructions. The processor 510 may be configured to execute computer-readable instructions, such as those stored in the memory 520, and through execution of the computer-readable instructions, the processor 510 is configured to perform one or more, or any combination, of the operations and/or methods described herein. The memory 520 may be a volatile or nonvolatile memory.

The electronic devices, processors, neural networks, processor 510, electronic device 500, memory 520, first neural networks 120 and 130, second neural network 210, first sub-neural network 250, second sub-neural network 270, third sub-neural network 290 described herein and disclosed herein described with respect to FIGS. 1-5 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-5 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating respective final feature vectors of a plurality of frames of time-series data, while sequentially processing the plurality of frames by using a neural network comprising a plurality of layers;
determining a class of the time-series data based on at least one final feature vector of the respective final feature vectors;
generating a reference feature vector based on the at least one final feature vector;
calculating a similarity score between the reference feature vector and a feature vector of at least one second frame, wherein the second frame comprises a non-final feature frame for which the final feature vector is not generated; and
determining the at least one second frame to be a frame corresponding to the class, based on a result of comparing the similarity score and a threshold value.

2. The method of claim 1, wherein the generating the respective final feature vectors comprises:
determining whether to proceed with a sequence for generating the final feature vector of a frame of the plurality of frames by using the layers for each of the plurality of frames; and
generating the final feature vector of the frame when the sequence reaches a final stage.

3. The method of claim 2, wherein the sequence comprises:
generating feature vectors, for each of a plurality of stages, of the frame by using a first neural network corresponding to each of the stages comprising the sequence; and
determining whether to proceed with the sequence by using a second neural network corresponding to each of the stages and the feature vectors for each of the stages.

4. The method of claim 1, wherein the neural network is configured to perform an operation for a frame of the plurality of frames based on an internal state of the layers calculated in a previous frame of which a final feature vector is generated.

5. The method of claim 1, wherein the determining the class comprises determining the class for a first frame comprising a frame determined to be the frame corresponding to the class of the at least one second frame or a frame of which a final feature vector is generated.

6. The method of claim 1, wherein the generating the reference feature vector comprises generating reference feature vectors for each stage corresponding to each of stages comprising a sequence.

7. The method of claim 1, wherein the generating the reference feature vector comprises determining, to be a reference feature vector for each stage, an average of feature vectors for each stage calculated for each of stages comprising a sequence corresponding to each frame of which a final feature vector is generated.

8. The method of claim 1, wherein a feature vector of the at least one second frame comprises a feature vector for each stage that is generated based on a sequence corresponding to the at least one second frame.

9. The method of claim 1, wherein a feature vector of the at least one second frame comprises a feature vector for each stage corresponding to a stage at which a sequence stops.

10. The method of claim 1, wherein the calculating the similarity score comprises calculating a similarity score between a feature vector for each stage corresponding to a stage at which a sequence stops corresponding to the at least one second frame and a reference feature vector for each stage corresponding to a same stage as the stage at which the sequence stops.

11. The method of claim 1, wherein the determining whether the at least one second frame to be the frame corresponding to the class comprises determining a second frame corresponding to the similarity score to be the frame corresponding to the class when the similarity score is greater than or equal to the threshold value.

12. The method of claim 1, wherein, when the time-series data is a video for detecting an abnormality in a production process, the class is the abnormality in the production process, and a first frame is a frame corresponding to the abnormality in the production process.

13. The method of claim 1, wherein, when the time-series data is streaming data and the class is a streaming filter, a first frame is a filtering target frame.

14. An electronic device, the device comprising:
a processor configured to execute a plurality of instructions; and
a memory storing the plurality of instructions, wherein execution of the plurality of instructions configures the processor to be configured to: generate respective final feature vectors of a plurality of frames of time-series data, while sequentially processing the plurality of frames by using a neural network comprising a plurality of layers;
determine a class of the time-series data based on at least one final feature vector of the respective final feature vectors;
generate a reference feature vector based on the at least one final feature vector;
calculate a similarity score between the reference feature vector and a feature vector of at least one second frame, wherein the second frame comprises a non-final feature frame where the final feature vector is not generated; and
determine the at least one second frame to be a frame corresponding to the class, based on a result of comparing the similarity score and a threshold value.

15. The electronic device of claim 14, wherein a first frame comprises a frame determined to be the frame corresponding to the class of the at least one second frame and a final feature frame where the final feature vector is generated.

16. The electronic device of claim 14, wherein the processor is configured to determine, to be a reference feature vector for each stage, an average of feature vectors for each stage calculated for each of stages comprising a sequence corresponding to each frame of which the final feature vector is generated.

17. The electronic device of claim 14, wherein the processor is configured to calculate a second similarity score between a feature vector for each stage corresponding to a stage at which a sequence stops corresponding to the at least one second frame and a reference feature vector for each stage corresponding to the same stage as the stage at which the sequence stops.

18. A processor implemented method, the method comprising processing, by a series of neural networks, a first frame of a plurality of frames of time-series data in a sequence;
determining, whether to stop the processing of the first frame before an end of the sequence;
generating a final feature vector for the first frame responsive to reaching the end of the sequence;
generating a first frame reference feature vector for the final feature vector; and
determining a class of the time-series data based on the final feature vector.

19. The method of claim 18, further comprising:
generating a second frame reference feature vector for a second frame responsive to stopping the processing of the second frame;
calculating a similarity score between the first frame reference feature vector and the second frame reference feature vector; and
assigning the second frame to the class based on a result of comparing the similarity score and a threshold value.

20. The method of claim 18, wherein the processing of the first frame comprises sequentially processing each frame of the plurality of frames until reaching the end of the sequence for the each frame or responsive to stopping the processing of the each frame.
